(19) United States
(12) Patent Application Publication
(10) Pub. No.: US 2011/0029618 A1
(43) Pub. Date: Feb. 3, 2011

(54) METHODS AND SYSTEMS FOR MANAGING VIRTUAL IDENTITIES IN THE INTERNET

(76) Inventors: Hanan Lavy, Ganei-Tiqva (IL); Dror Zernik, Haifa (IL)

Correspondence Address: Credint Interactive LTD c/o Hanan Lavy, 4/22 Rav-On Street, Ganei-Tiqva, 55900, omitted

(21) Appl. No.: 12/534,129

(22) Filed: Aug. 2, 2009

(51) Int. Cl. G06F 15/16; G06F 15/173; G06N 7/04

(52) U.S. Cl. 709/206; 709/224; 706/54

(57) ABSTRACT

The present invention discloses methods and systems for managing and maintaining identities over time within the practically anonymous Internet environment. Said system and methods provide protection by tracking identities of partners over time, within multiple relations and over-riding common practices for identity switching.

### FIELD AND BACKGROUND OF THE INVENTION

The present invention relates to methods and systems for uniquely identifying, validating and evaluating identities of Internet users and the nature of their activities and the relations they are involved in.

### SUMMARY

It is the purpose of the present invention to provide methods and systems for identifying the people as they appear in the Internet and their characteristics over time, and in particular the nature of the relations these people are involved in, and the activities they take part in. Such a service could provide ‘quality assurance’ even to anonymous identities. Three possible usages of such a method are:
a. To protect children from on-line predators.
b. To provide quality stamp for content that is provided by identified as well as anonymous Web 2.0 users.
c. To protect against virtual identity thefts.
   The core capability of the invention is the ability to track people and relations over time, rather than just to look at a two-people-interaction as a one-time incident, or at a person submitting content to the Internet as a single event. The invention refers to the accumulated relations as they are developing between the various personalities involved in order to provide assurances and quality of (virtual) people over time in the Internet in a similar way that a credit company relates to credit history. This is referred to as ICredit.

Embodiments of the present invention allows for accumulating identities of seemingly anonymous Internet users, and ensuring that while two anonymous people are interacting on-line:
(1) The nature of the relations evolvement and trace records of both participants is maintained and used for any of the following:
   a. Ensuring professional level;
   b. Alerting for dangerous behavior or suspicious traces in history.
   c. Guaranteeing the authentication of the partners to the aspects required;
(2) Gather early indications for malicious intentions during the relations, and
(3) Generate a relevant warning accordingly
Similarly when one of the persons submits content to an Internet site (Web 2.0 style):
   (1) The personality historical records of the person indicate a sufficient reliability according to the site submission criteria.
Another embodiment of the invention can be used for preventing identity theft in the Internet;
Yet another embodiment of the invention allows it to be augmented also for instant messaging over the cellular as a part of said relations.
Yet another embodiment of the invention allows it to be used for alerting parents or authorized personnel regarding a threat to their child.

Embodiments of the present invention include the following two core aspects.
(1) Generating a finger print for each virtual identity—this allows for overcoming anonymity challenges; the finger prints can use one or more sources of information:
   a. Computer-based data: using forensic techniques to uniquely identify the computer/connection to the Internet, or similarly the telephone identity.
   b. Identity data—the declared identity of the person, such as the nickname the person chooses, e-mail, and other identities;
   c. Content related—the text and content that the person is publishing or stating during chat sessions and Internet sessions. For example a use of unique slang or language errors, or the provision of unique images or set of such contents.
      This is well established in patents and literature (Cyota, and others), however the use here is new.
(2) Monitoring the relation graph for each personality with the various sources, which is pattern based:
   a. Interaction evaluation engine—which reviews and evaluates the content generated by the observed identity—including text, images, and video —in each relation the identity is involved in, over all the channels the entities are connected and
   b. Deduction of quality of relations from other interactions of one party.

A possible embodiment might also contain the following aspects:
(3) Generating honey-traps:
   TO attract criminals and gather incriminating evidence for the identity;
   For gathering typical behavior reference data;
(4) Pattern analysis—to track the various states that relations can be in, as well as to define personality ICredit;
(5) Tracking compliance to some criteria over time, and then generating an alert or a measurement:
   To an authorized person or a relevant authority—in cases of danger, or deviation from desired standard; (for example—publishing a gossip letter in a Web 2.0 site or being involved in pedophile relations with a child).
A ‘credit-ranking’ indication—which is associated with the identity within interactions with other persons or sites.

The current invention is designed to provide a varying degree of assurance while allowing the common anonymity that Internet users want to preserve. Using the new methods and systems a person can have a large variety of ‘authentication’. For example:
Unknown anonymous—an unknown person with no ICredit history or real-world identification data; might be a dangerous identity—but the system does not have sufficient data to generate an indication.
Reliable anonymous—an anonymous person—who has gained sufficient ICredit history, but has not provided any real-world authentication; this might be sufficient identification for chat rooms and for content in Web 2.0 sites.
Reliable credible anonymous—an anonymous (for the sake of the interaction) person—who has gained sufficient ICredit history and has also identified himself to the system with real-world identification; this might be useful for transactional committing forums.
Professionally authenticated anonymous—a person who's either ICredit history or identification guarantee the specific profession in question; this might be useful for professional forums.
Identified credible—a person who is identified to the interaction partner, but needs certification from the system—that this is really the person. This might be useful for e-mail filtering.
Identified dangerous—a person whom the system identified as a source of unreliable or dangerous intentions—depending on the context; this might be valuable for generating an alert regarding on-line predators or for ranking content on Web 2.0 sites as unreliable.

### USAGE EXAMPLE I

### Anonymous Journalist in Web 2.0

Consider as an example a person that wants to submit a content file (video, image, recording, document, or just an opinion, etc.) to a Web 2.0 site, (such as YouTube). The person may choose to remain anonymous for various reasons:
The content contains information which is incriminating for a third party (in real life) that the person fears;
The content contains an opinion that is not consistent with the common opinion of the person in real life.

At the same time, the credibility of the content is vital for the degree of the exposure and the weight that the content will receive. By using the current invention, the person as well as the site owner can ensure that the person is a credible person, without ever having to provide identifying information not desired by the person—to the site or to the public.

### USAGE EXAMPLE II

### Child Protection

Consider a person that interacts with friends in a chat room; this person identifies him/herself as J13; consider now two scenarios:
1. That someone maliciously uses the name J13, and tries to establish relations with people on the Internet, that trust J13 (identity theft) or
2. That someone K14 establishes malicious relations with J13, assuming that the number 13 indicates a child age.

In the first case it is important to indicate to J13 partners that the new J13 is not really their J13 partner. The current invention can provide automatically such an indication, or can provide the indication if requested (on demand). The indication may also be sent to J13—to alert him for his identity theft. Note that such relations may start in a chat room, move on to private (one-on-one) session, and refer also to e-mail or other communication interfaces such as allowed over the Internet, or over cellular networks.

In the second example it is desired to indicate to J13 that K14 is has these malicious intentions as early as possible, before any damage is caused to J13.

The current invention can provide an alert to J13 or to some third party about this even before any indication has been established in the relations between J13 and K14, based on similar relations of K14 with some other person, say J12. This assumes that K14 is known to the system and has some negative ICredit. Such negative ICredit is accumulated in the invented system, using the forensic methods mentioned before, thus ensuring uniquely identifying the person.

### USAGE EXAMPLE III

### Web 2.0 Forum—Content Filter

Consider a Web 2.0 forum manager, such as a blog-space owner. In the spaces provided by such a service people write their opinions about the world, including other people. The space owner is legally exposed as malicious users can publish harmful content that harm the reputation of people, or which is illegal in some other way. The site owner needs to filter such contents based, among the rest, on some properties of the content contributors. It is desired that the content contributor can establish such ICredit that when he submits a ‘provocative’ of controversial content, it can be trusted due to the credibility of the content contributor.

### BRIEF DESCRIPTION OF THE DRAWINGS

The present invention is herein described, by way of example only, with reference to the accompanying drawings, wherein:

FIG. 1 is a high-level schematic block diagram of the current state-of-the-art—where chat users interact using the Internet and a chat-server;

FIG. 2 is a high-level schematic block diagram of one possible embodiment of the system—where the detection piece (referred to as ICredit content evaluation server,) is installed ‘in-the-cloud’—in the Internet infrastructure;

FIG. 3 is a high-level schematic block diagram of an additional possible embodiment of the system—where the detection piece, ICredit content evaluation client, is installed on the end-computers; this might be a desired configuration for children who use a home computer;

FIG. 4 is a schematic diagram showing a schematic model of the development of pedophile relations over time;

FIG. 5 is a high-level schematic block diagram of one possible embodiment of the honey-trap—the chat-agent (chat-robot).

FIG. 6 provides two examples of possible alerts and credit certifications services.

### DESCRIPTION OF THE PREFERRED EMBODIMENTS

The present invention relates to methods and systems for managing identities, including anonymous identities within the Internet. The principles and operation for such methods and systems, according to the present invention, may be better understood with reference to the accompanying description and the drawings.

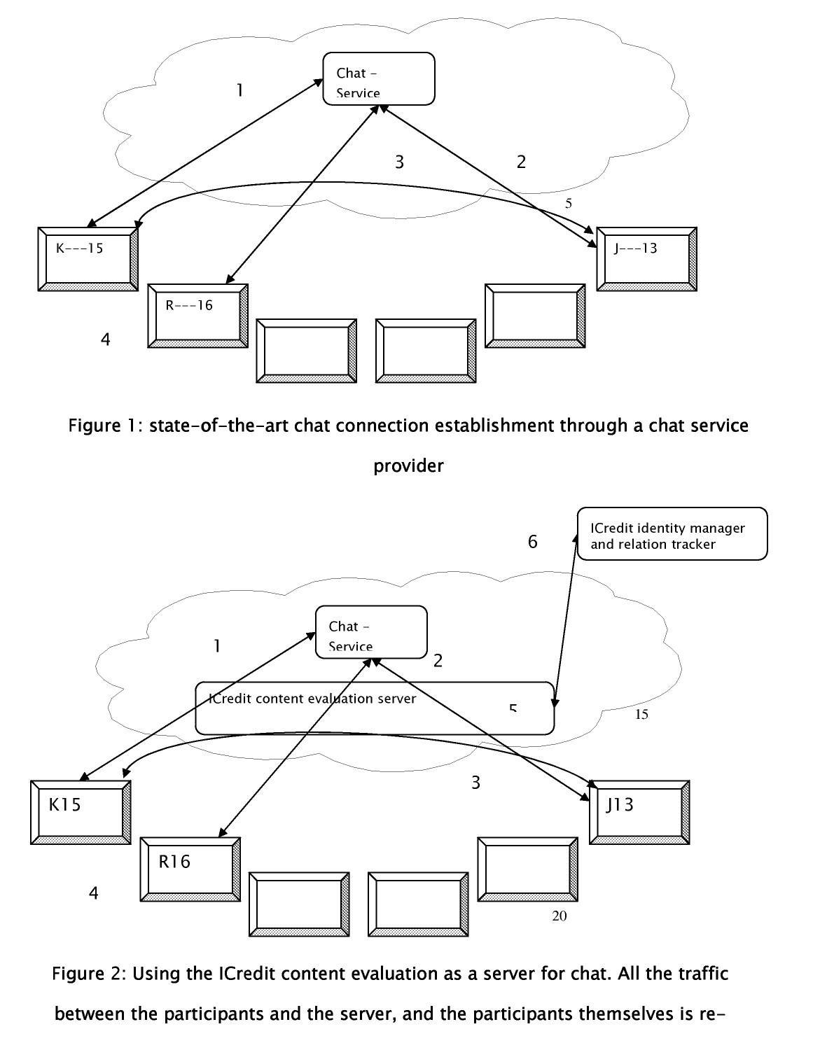

Referring now to the drawings, FIG. 1 shows the current situation: three chat partners, J13, K15 and R16 access a chat service. Once J13 and K15 are authenticated with the chat service provider by the communication indicated by numbers 1 and 2, J13 and K15 establish a direct chat session marked by the number 3.

In another possible scenario—R16 may either not be socially related to the other two participants, or they have not authorized him to view their status. In yet another scenario—the chat occurs in a ‘public room’ in which case all the communication can be hosted by the chat provider.

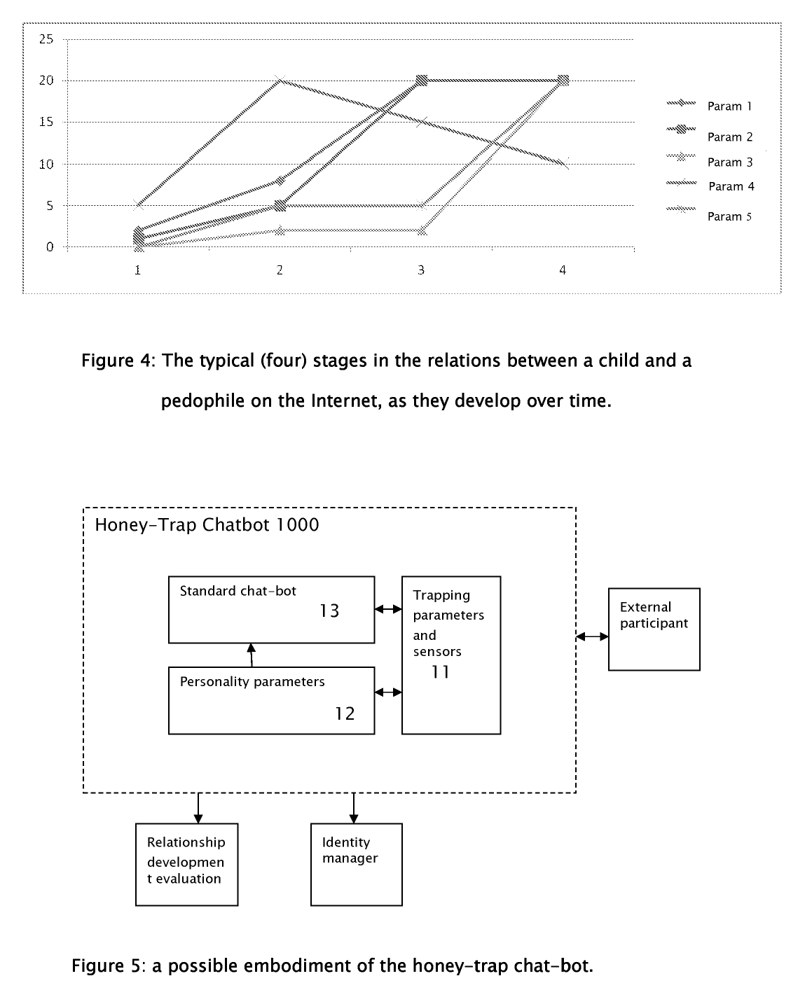

Using the current invention, as depicted in FIG. 2, all the chat contents and interactions are routed through an additional ‘content verification server’ marked by No. 5, which scans through the transmitted content and interacts also with the ‘ICredit identity manager and relation tracker’ marked by the No. 6. The identity manager 6 notifies each of the participating chatters about the ‘credit quality’ of their partners; it also receives the grades and marks of the content analysis server, and updates the user profiles accordingly. If necessary, a deeper analysis of relations pattern is performed by the ‘relation tracker’ as well. If for example the relations between J13 and K15 seem to indicate that K15 has malicious intentions, (as depicted according to FIG. 4)—indicating a pedophile intention, any future interaction of K15 with kids, such as R16, may be alerted—even before such an intention can be detected in the interactions with R16.

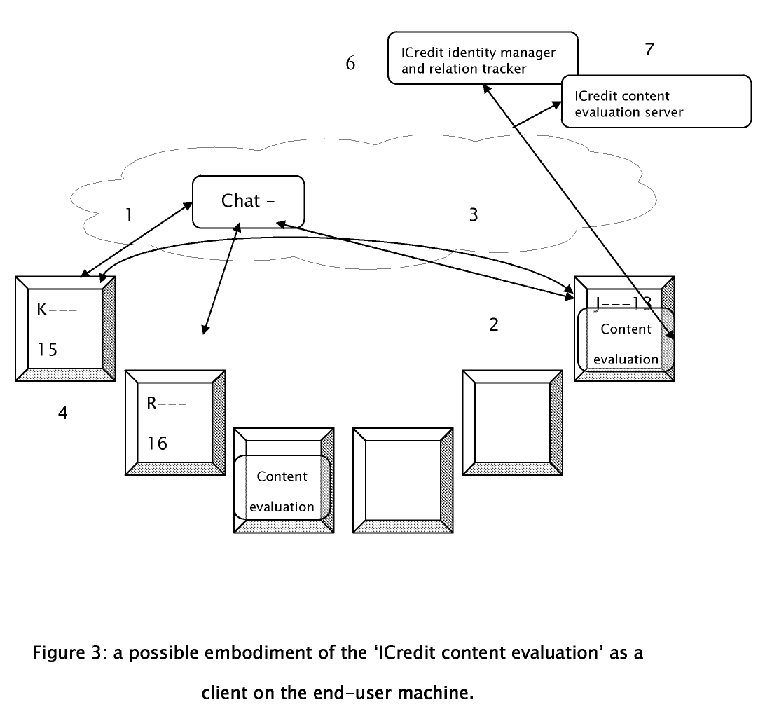

FIG. 3 shows a possible alternative embodiment where instead of rerouting the communication through a content analysis server, a client is installed on participating customer's computers. Same scenario as before can be supported, as long as both K15 and R16 are registered for the service, and have the content analysis client running on their machine. In this case a much deeper analysis is performed on the content analysis server No. 7.

In order to track identities, even in the presence of multiple names for the same identity the identity management module can use a finger print which is based on multiple parameters of the computer used by the identity. This starts with the IP address of the machine, but typically includes many other parameters which uniquely identify with high probability the given computer. This finger print is gathered from non-customers by injecting a Java script or Flash or Active X during an interaction with a customer, (chat or e-mail support such an injection), and thus gathering the needed finger print. Given a uniquely identifying finger print, multiple virtual identities can be aggregated into a single physical identity.

FIG. 4 shows the four typical stages in pedophile relations:

Stage 1: Introduction—in this stage the pedophile (P) gets to know the child (C); P gathers as much information about the child, and directs the child to a private (one-on-one) chat session. Random friendly chat and general interests are covered.

Stage 2: Interrogation—P gathers detailed data about C, by asking naive questions and by showing a lot of interest. The interaction frequencies and the session duration rise. Questions about school, family, house, habits, and friends are typical for this stage. Trust is being built.

Stage 3: Isolation—in this stage the child is isolated; indications that P is the only person C can trust are common in this stage. Possible indications that P is an adult are already conveyed (explicitly). In this stage psychological damage begins to build.

Stage 4: Sexual desensitization—sexual related questions and requests are transmitted at this stage; P is aroused by C describing intimate activities. Request to perform sexual activities and to describe these activities are common. P often sends pedophile images to C, in order to legitimize such relations.

In some cases a meeting may follow. It is important to understand that the various stages typically take months.

There are many parameters that isolate the different stages. FIG. 4 shows a small sample:
Session duration
Session frequency
Informative questions
Instructive statements with sexual connotations
Sexual content (including text, videos and images)

There are many additional parameters which allow for constructing a mathematical model for each of the stages. It is the responsibility of the ‘ICredit—relation tracker’ of FIG. 3 to analyze the patterns and status of each such relations (for any P and C who are in direct contact).

A similar model can be provided for several targeted chat rooms—such as dating, and professional rooms.

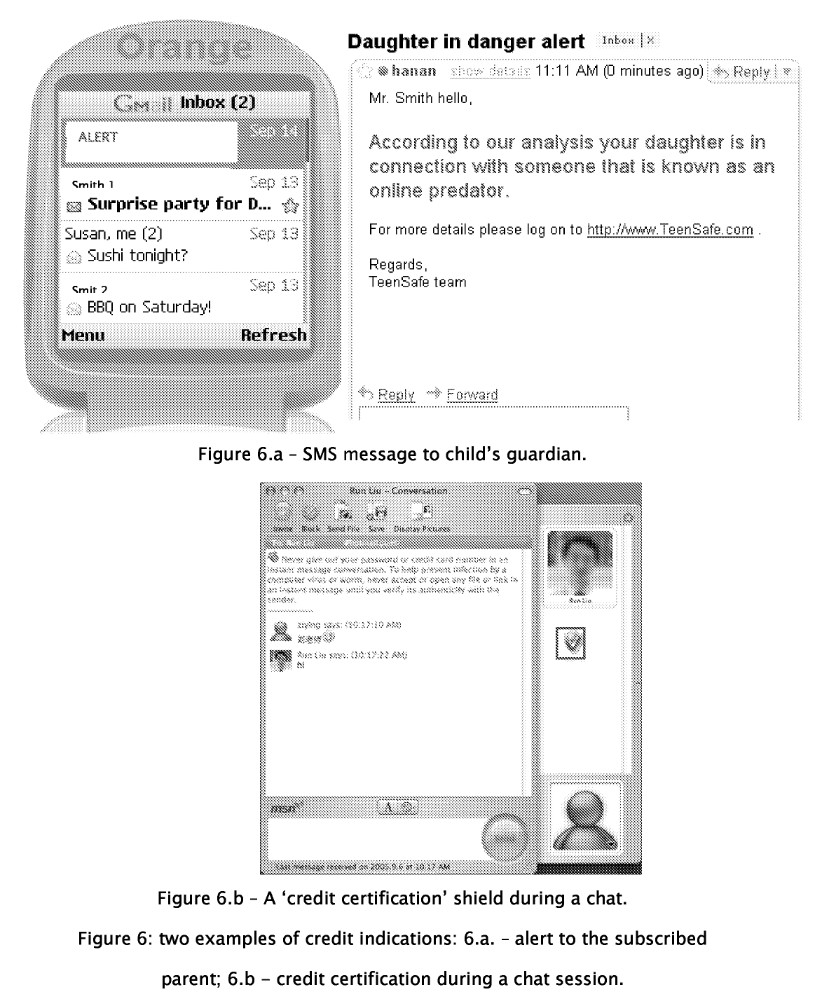

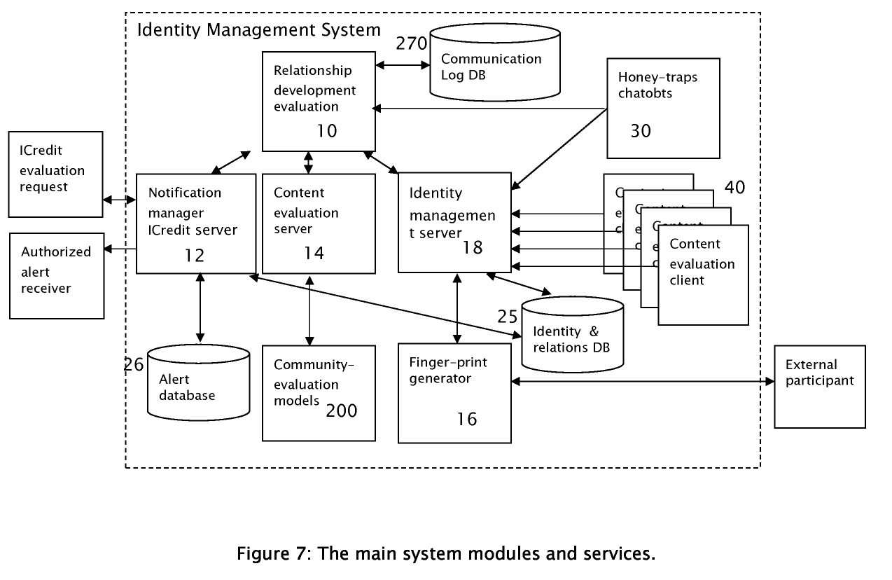

If a suspicious or dangerous pattern is detected, the ‘relation tracker’ can generate some alert to the relevant authorized people regarding possible danger. This is performed via the ‘notification manager’ of FIG. 7. Two sample indications are shown in FIG. 6.

FIG. 6.a shows an SMS which can be sent to the parent of a child who is involved in relations with a person who is engaged in pedophile relations—either with this specific child or even just with other children.

FIG. 6.b shows an alternative embodiment where a service is established for providing ‘level of trust’ for counter parts. The picture shows a possible use within a chat session, but a similar service can be provided for Web 2.0 site owners.

FIG. 5 shows a simple construction of a honey trap chatbot 1000; in order to begin to accumulate the information needed for both the mathematical stage model as well as for accumulating a head-start for pedophile suspects. A possible embodiment can use a chatbot; this is a chatting software agent (robot), which is now common practice in prior art. However, this chatbot is configured to accept personality parameters which allow to a. give the virtual identity personality parameters and b. to adapt it to different (not just pedophile) applications. In addition the chatbot is configured to generate indication outputs according to the ‘trapping parameters’. This design allows the chatbot to continue seemingly innocent conversations until the ‘relation tracker’ believes that the relations have reached the desired stage.

Within the system the chatbot is interfacing the Identity Manager and the Relationship Development Evaluation Modules (Shown later in FIG. 6).

FIG. 6 shows two possible user interfaces of the system; FIG. 6a. shows a possible alert message which has been transmitted to an authorized person, in relation to a child being exposed to a pedophile threat; this can represent any dangerous relations a child or an adult subscriber are exposed to—which the system detects.

FIG. 6b. shows an alternative interface where the system provides ‘quality shields’—allowing users to estimate the ICredit of their partners.

In FIG. 7 a detailed description of the preferred embodiment is provided. This includes several usage scenarios: When the external participant contacts one of the system users, who (in one alternative) has a system client (400) on his computer, the identity management server (180) looks for this external user details in the identity relations DB (250). The finger-print generator (160) collects all the up-to-date information from the external participant using the forensic detection methods mentioned above.

If the external participant does not appear in the identities and relations DB (250), the fingerprint obtained from it is matched to the all known fingerprints that are maintained in the identities and relations DB (250).

If a sufficient match is found, the new external participant is assumed to be the same entity. Otherwise, a new entity is entered and it may be matched later, using both forensic methods or identification methods.

During a conversation, or periodically, an evaluation process is invoked, which uses the Content evaluation module (140). This module depends on the specific community involved in the chat. In the case of children protection, this reflects the parameters defined as exemplified in FIG. 4. In other cases a different model is used to define the Content evaluation Module parameters. This is provided by the Community evaluation Models (200). The content evaluation process of module 140 can generate an indication, which is then transferred to the relationship development module (100). This is an indicating that the model has detected a possible deviation. When an alert is triggered it is stored in Alert database (260) with all the reasoning of what caused it to be triggered, the Notification manager ICredit server (120) will also write in Identity & relations DB (250) that the external participant that has contacted our client (400) was identified as a person with risk level. The number of alerts triggered and their level will be maintained in order to determine the risk-likelihood of this external participant when this person will be contacting other clients of the system (other instances of 400). If the External Participant is in contact with additional subscribers alerts can be issued to them as well, based on the understanding that this virtual identity generates risks.

When the authorized alert receiver of the system subscriber (of client 400) receives an alert the person can contact the Notification Manager ICredit server (120) and get the logic that caused the alert to be triggered. The Notification Manager ICredit server (120) gets this data to be presented to the parent from the Alert database (260).

The Honey Traps chatbots (300) described in detail in FIG. 5, are conceived by the system as not much more than an additional client. The interactions with them by external participants is monitored and triggered like other relations. In addition, though the honey-traps chatbots 300 can also notify the relation Relationship development evaluation 100, when an internal alert has been triggered by the ‘trapping parameters and sensors 1100’ of FIG. 5.

In another scenario, the system can be configured to provide ICredit rating services per request. This is demonstrated by the ‘ICredit Evaluation Request’ which is entered into the system with the appropriate parameters; in order to support such a service a subscriber needs to register with the Notification Manager 120, which then activates the system, and tracks the identities in a similar manner.

In this FIG. 6 we assumed for simplicity that the monitoring of relations is performed by using clients (as denoted in FIG. 3). As discussed before this is just one possible embodiment, and in FIG. 2 a client-less configuration is shown. If a client-less configuration is selected than the clients are simply identified by the system's Identity management server 180.

What is claimed is:

1. A system for identifying and maintaining identities within the de-facto anonymous Internet environment, said system comprises of:
i. Finger-print generator—which uniquely identifies a computer, a user, and a participant in chat rooms and social networks;
ii. Activity-tracking over time—which monitors the activity of said identities and the changes in these activities within the Internet.
iii. Content evaluation mechanism—for identifying sensitive content.
Said system provides services of validating reliability, trust and credibility of the identities, and the content they provide.

2. The system of claim 1 that also uses chatbots that serve for data collection and honey traps.

3. The system of claim 1 where the content evaluation is performed by either a client installed on end-user machines or a server on the Internet.

4. The system of claim 1 where notification is transmitted to a guardian or an authority regarding possible danger;

5. The system of claim 1 also providing credit-like ranking for partners in social interactions over the Internet.

6. The system of claim 1 further used for filtering social networks, and generating content alerts to the social network owners or operators.

7. The system of claim 1 further used as a service to third parties for anonymous confirmation of participants credibility without giving up the participants anonymity.

8. The system of claim 1 where the communication is augmented to Instant Messages over cellular phones.

9. The system of claim 1 where the communication is carried out using mail or other communication protocols.

10. The system of claim 1 where the interaction over time is compared to a mathematical model which reflects relations between pedophiles and children.
